(19) United States
(12) Patent Application Publication
(10) Pub. No.: US 2001/0014601 A1
(43) Pub. Date: Aug. 16, 2001

(54) Client server system for mobile phone

(76) Inventor: Tatsuru Kuwabara, Kariya-city (JP)

Correspondence Address: FISH & RICHARDSON, PC, 4350 LA JOLLA VILLAGE DRIVE, SUITE 500, SAN DIEGO, CA, 92122, US

(21) Appl. No.: 09/784,994

(22) Filed: Feb. 14, 2001

(30) Foreign Application Priority Data
Feb. 14, 2000 (JP) 2000-34974
Mar. 9, 2000 (JP) 2000-65539

(51) Int. Cl. H04M 11/10

(52) U.S. Cl. 455/412; 709/310

(57) ABSTRACT

A client terminal such as a mobile phone used in a client server system includes a locator for locating an exclusive server and a browser for downloading special information stored in the exclusive server. The exclusive server is provided and administered by a terminal maker to supply information exclusively to its clients who use the terminal it makes. The locator and the browser are installed in the client terminal before the terminal is sold. The client server system may be designed to automatically change an initial display on the client terminal to give the client an additional amusement upon access to the exclusive server.

### CROSS-REFERENCE TO RELATED APPLICATIONS

This application is based upon and claims benefit of priority of Japanese Patent Applications No. 2000-34974 filed on Feb. 14, 2000 and No. 2000-65539 filed on Mar. 9, 2000, the contents of which are incorporated herein by reference.

### BACKGROUND OF THE INVENTION

1. Field of the Invention

The present invention relates to a client server system in which a client terminal such as a mobile telephone is connected to a particular server to obtain information stored therein.

2. Description of Related Art

Client terminals such as personal computers or mobile telephones can be connected to various servers provided and maintained by individuals or companies through the internet. A user of the client terminal searches sites with a browser and downloads desired information or data from the sites. The information or the data may be displayed on a display panel of the client terminal in a form of images or characters. Alternatively, such information or data may be obtained in a form of sound information.

Taking a mobile phone as an example, there are various kinds of phones made by different makers. When a mobile phone user has access to a particular site, any user can equally obtain the same information from the site, not depending on the kinds of phone he uses in a conventional client server system. This means that a particular phone maker is not able to offer an advantage to a user who uses the phone made by the particular phone maker as long as the client server system is concerned. It is desirable for the phone maker to be able to give merits to the user of the phone it makes in a client server system.

### SUMMARY OF THE INVENTION

The present invention has been made in view of the above-mentioned problem, and an object of the present invention is to provide a client server system in which a client terminal maker is able to offer particular merits to a user of the terminal it makes. Another object of the present invention is to provide a mobile phone as the client terminal which is able to enjoy the particular merits in the client server system.

In a client server system, a client terminal such as a mobile phone communicates with an exclusive server administered by a phone maker through a server administered by a telephone service provider. The phone maker supplies particular information or service from its exclusive server only to the specified clients who uses the phone it makes. For this purpose, the phone maker pre-installs a locator for locating the exclusive server and a browser for downloading the particular information in the phone it makes together with a code identifying the phone maker. Users who use a phone made by other phone makers are excluded from the particular information stored in the exclusive server.

A code identifying the telephone service provider is also included in a data format sent from the user to the exclusive server through the provider's server. Only when both codes identifying the phone maker and the provider are justified as authentic ones upon receipt of such codes by the exclusive server, the particular information stored in the exclusive server is made available to the user. Such information can be downloaded from the exclusive server to the client phone. In this manner, a user who is not under control of the provider is precluded from the access to the exclusive server.

A data format sent from the provider's server to the exclusive server consists of a header field and a data field, and at least the code identifying the phone maker is contained in the data field to effectively prohibit an unauthorized access to the exclusive server. The exclusive server may include information which is available also to the public other than the specified clients.

The exclusive server may be designed to send a special command together with the information to the client. Upon receipt of the special command, a setting of the mobile phone of the specified client is changed, so that the specified client using the phone made by the administrator of the exclusive server enjoys a special service. For example, the a message or an image displayed on the client terminal is changed upon receipt of the special command, or sound information such as music is changed. Data necessary to make such a setting change may be pre-installed in the client terminal or may be downloaded from the exclusive server together with the special command.

The client terminal maker is able to give special merits to its clients through the services in the client server system according to the present invention.

Other objects and features of the present invention will become more readily apparent from a better understanding of the preferred embodiments described below with reference to the following drawings.

### BRIEF DESCRIPTION OF THE DRAWINGS

FIG. 1 is a schematic view showing a client server system;

FIG. 2 is a functional block diagram showing a mobile phone;

FIG. 3 is a chart showing a process of supplying a mobile phone from a phone maker to a telephone service provider;

FIG. 4 is a chart showing a communication process in a client server system as a first embodiment of the present invention;

FIG. 5 shows a TCP/IP data format used in the client server system as the first embodiment;

FIG. 6 is a chart showing a communication process in a client server system as a second embodiment of the present invention;

FIG. 7 is a flowchart showing the communication process performed in the client server system as the second embodiment;

FIG. 8 shows a TCP/IP data format used in the client server system as the second embodiment;

FIG. 9 is a chart showing a communication process in a client server system as a third embodiment of the present invention; and

FIG. 10 is a flowchart showing the communication process performed in the client server system as the third embodiment.

### DETAILED DESCRIPTION OF THE PREFERRED EMBODIMENTS

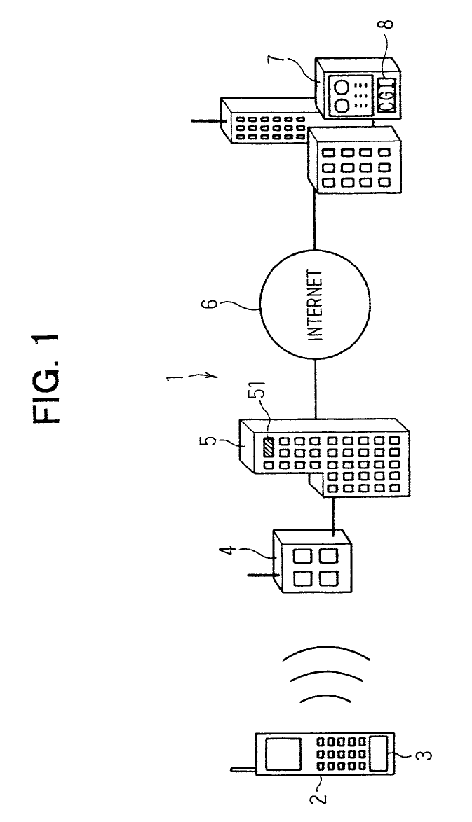

A first embodiment of the present invention will be described with reference to FIGS. 1-5. First, referring to FIG. 1, a client server system 1 will be briefly described. A wireless mobile phone 2 as a client terminal includes a browser 3 for downloading contents in a home page, or a world-wide-web site, into the mobile phone 2. It is assumed in this description that the mobile phone 2 is made by a phone maker D, and the browser 3 is pre-installed in the phone 2 before the phone 2 is supplied to a telephone service provider, as shown in FIG. 3. The mobile phone 2 communicates with other phones or other client terminals through a terminal station 4 controlled by a telephone service provider 5. The mobile phone 2 also has access to a provider's server 51 through the terminal station 4, so that the provider can provide service information to the user. The user may download the service information to his mobile phone 2. The provider's server 51 is connected to an exclusive server 7 via the internet 6. The exclusive server 7 is controlled by the phone maker D to supply various information and data especially to the user of the phone made by the phone maker D. The exclusive server 7 includes an interface software (CGI) 8 for controlling access of the clients thereto.

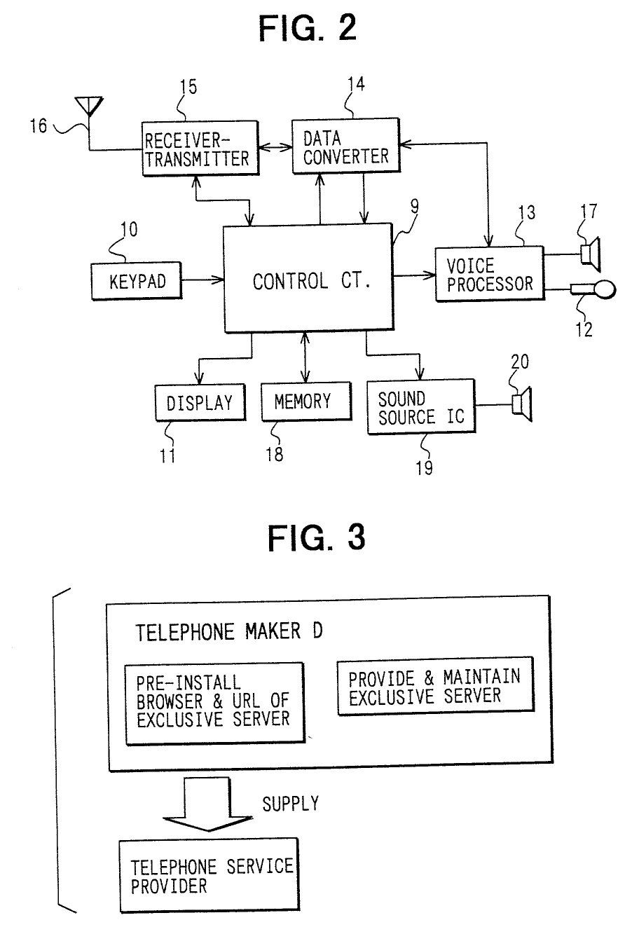

Referring to FIG. 2 showing a block diagram of the mobile phone 2, the function of the mobile phone 2 will be briefly explained. The mobile phone 2 includes a control circuit 9 mainly composed of a microcomputer. Instruction signals are fed to the control circuit 9 from a keypad 10 connected to the control circuit 9. The control circuit 9 controls, among other things, operation of a display panel 11 such as a liquid crystal display panel. Voice signals to be transmitted are fed to a microphone 12 and are converted into digital signals through a voice processor 13. Then, the digital signals are fed to a data converter 14 which converts the digital signals into π/4-shift DQPSK (Differential Quadrature Phase Shift Keying) signals. The DQPSK signals are orthogonally modified by a carrier signal (e.g., 800 MHz) in a receiver-transmitter 15 and transmitted from an antenna 16 as a radio wave. On the other hand, when the antenna 16 receives a radio wave, the ratio wave is demodulated through a route opposite to the above and converted into analog signals which are output from a speaker 17.

The control circuit 9 controls operation of the voice processor 13, the data converter 14 and the receiver-transmitter 15. A memory 18 composed of components such as ROM, RAM and BEPROM is connected to the control circuit 9. The control circuit 9 writes data in the memory 18 and reads out the data from the memory 18. A sound source IC 19 is an integrated circuit for generating sounds notifying a call-arrival or a mail-arrival. The sounds generated in the sound source IC 19 including sound patterns and melodies are output from a speaker 20.

The mobile phone 2 is structured to be able to perform data communication in addition to voice communication. The browser 3 is stored in the memory 18, and it is read out by the control circuit 9 and executed. The memory 18 also stores therein a URL (a locator) for connecting the mobile phone 2 to the exclusive server 7, so that the phone is easily connected to the exclusive server 7 by operating the keypad 10. The locator is pre-installed in the mobile phone 2 by the phone maker D before the phone is supplied to the telephone service provider, as shown in FIG. 3.

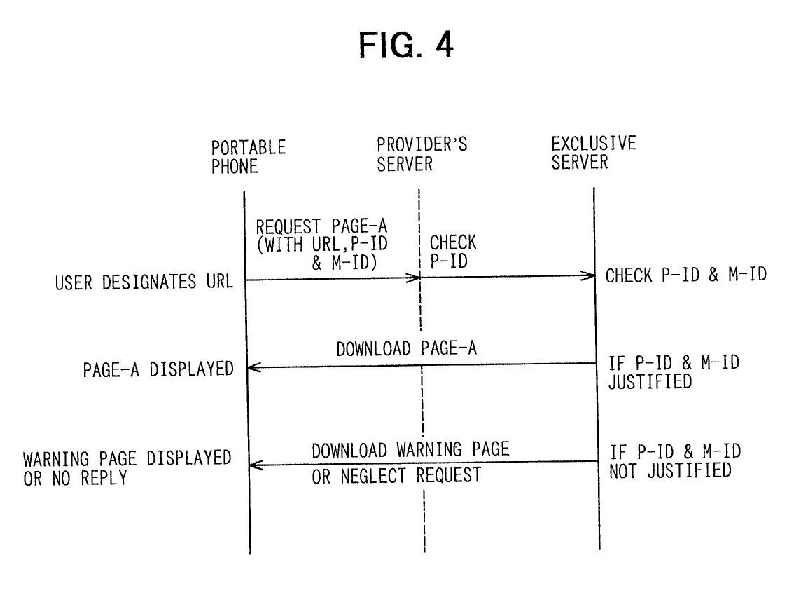

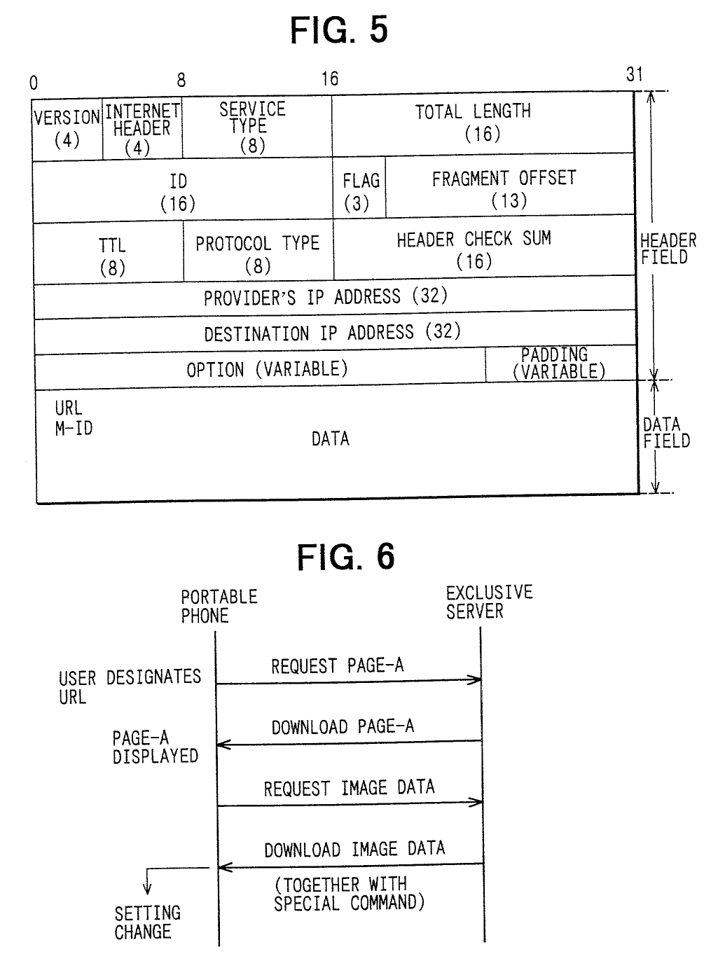

Referring to FIGS. 4 and 5, operation of the client server system 1 will be described. FIG. 4 briefly shows an operation sequence in which the phone 2 is connected to the exclusive server 7 to download contents stored therein. Communication between the provider's server 51 and the exclusive server 7 is performed under the TCP/IP (Transmission Control Protocol/Internet Protocol). Communication between the phone 2 and the terminal station 4 can be performed in various ways including the TCP/IP. It is assumed that the mobile phone 2 is made by the phone maker D and the exclusive server 7 is administered and controlled by the phone maker D.

First, the user of the phone 2 starts the browser 3 through the keypad 10. A frame showing locators (URLs) memorized in the memory 18 are displayed on the display panel 11. The user selects a URL for requesting a top page-A in the exclusive server 7 from among the displayed locators. The communication data for requesting the page-A include a provider identification (P-ID) and a phone maker identification (M-ID). The provider's server 51, upon receipt of the page-A request, checks the P-ID to determine whether the P-ID is the provider's own identification or not. If the P-ID is justified (if the P-ID is the provider's own ID), then the provider's server 51 sends data written in a predetermined communication format to the exclusive server 7.

The predetermined communication format is a known format as a TCP/IP data format, which is briefly shown in FIG. 5. This format consists of a header field and a data field. The URL for locating the exclusive server 7 and the M-ID indicating who made the phone 2 now being used are written in the data field. Unauthorized access to the exclusive server 7 can be more strictly prohibited by writing the M-ID in the data field, in which the identification can be freely written, than by writing the M-ID in the header field which has a fixed format.

Upon receipt of the communication data written in the TCP/IP format, the exclusive server 7 determines whether both IDs, the P-ID and the M-ID, are justifiable or not. This process is performed to check whether a user who is not under the service of the provider is trying to enter the exclusive server 7 and whether a user who is using the phone made by other makers is seeking an access to the exclusive server 7. If both the P-ID and the M-ID are justified, the exclusive server 7 allows the user to download the requested page-A as an HTML (Hyper Text Makeup Language) source file. The HTML source file is downloaded into a RAM in the memory 18 of the mobile phone 2. Then, the browser 3 analyzes a code of the HTML file, and displayable information is displayed on the display panel 11. If image data such as picture data are included in the source file, such image data are requested to be sent to download the same in the phone 2. The data downloaded in the phone also includes sound data such as music.

On the other hand, if either one of the P-ID or the M-ID is not justified in the exclusive server 7, the access to the exclusive server 7 is rejected, or a warning page is sent to such a user to be downloaded in his terminal. Thus, an unauthorized access to the exclusive server 7 is prohibited. This means that the contents stored in the exclusive server 7 are supplied only to the users who use the phone 2 made by the phone maker D. In this manner, the phone maker D is able to differentiate its own phones from other makes in providing the users with special information. Further, since the URL for locating the exclusive server 7 of the phone maker D and the browser 3 are pre-installed in the phone 2, the phone maker D can provide an incentive in selling its phone.

Though a user who uses a phone made by a maker other than D is prohibited from obtaining any content in the exclusive server 7 in the foregoing embodiment, it is possible to allow such a user to have access to certain contents in the exclusive server 7. Though the exclusive server 7 is administered and controlled by the phone maker D itself, it is also possible to entrust the administration of the exclusive server 7 to someone else, as long as the pre-installed browser 3 matches the interface CGI program 8 in the exclusive server 7. Though the provider's IP address written in the header field is used as the P-ID, the provider may give his server 51 a special identification code which is written in the data field. Though the mobile phone is used as a client terminal in the client server system described above, other client terminals such as a PHS (Personal Handy-phone System) or a personal computer having a modem may be used as the client terminals.

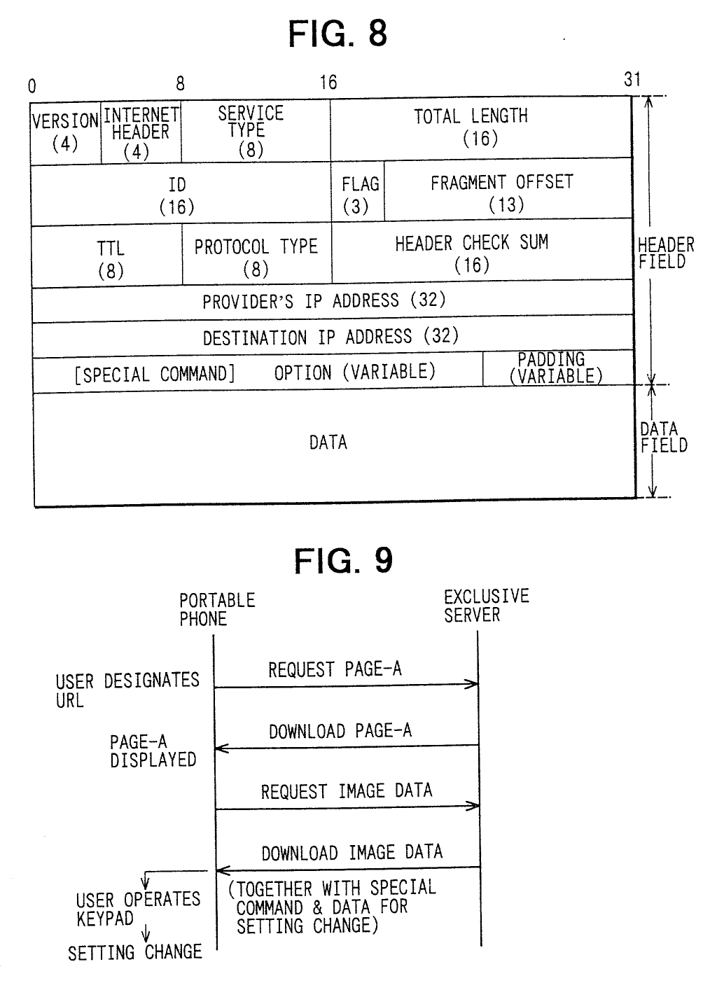

A second embodiment of the present invention will be described with reference to FIGS. 6-8. A client server system as the second embodiment is similar to the first embodiment described above. Therefore, only the points peculiar to this embodiment will be described below. In this embodiment, data for changing a setting of the phone 2 are included in the memory 18 of the phone 2. Those data are read out from the memory 18 and used when the phone 2 receives a special command (explained later) sent from the exclusive server 7.

A communication process between the phone 2 as a client terminal and the exclusive server 7 administered by the phone maker D will be briefly described with reference to FIG. 6. The user designates the URL for locating the exclusive server 7 and requests the page-A. The exclusive server 7 sends the requested page-A as an HTML source file to be downloaded in the RAM 18 of the phone 2. Then, the browser 3 analyzes the code of the HTML source file to display displayable information on the display panel 11. If image data such as pictures are included in the source file, the client terminal requests such image data to be sent from the exclusive server 7. A special command to change the setting of the phone 2 is included in the header field of the TCP/IP data format, as shown in FIG. 3. The special command is recognized as such only by the phone 2 that includes the setting change data in the memory 18, i.e. only by the phone 2 made by the phone maker D.

Upon receipt of the image data, that image is additionally displayed on the display panel 11. If the special command is included in the image data, the data for changing the setting of the phone 2 is read out from the memory 18. The setting change is done in various ways. For example, a background image shown on the display panel 11, when the phone 2 is in a waiting state, may be changed. Alternatively, a letter message pattern shown on the display panel 11 or a melody output from the speaker 20 may be changed.

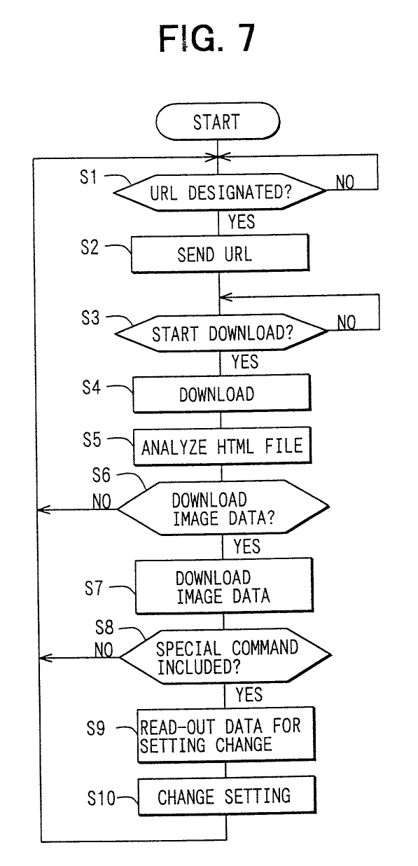

Some more details of the communication process briefly described above will be explained with reference to a flowchart shown in FIG. 7. Whether the URL for locating the exclusive server 7 is designated is checked (step S1). If the URL is designated, the URL is sent to the exclusive server 7 (step S2), requesting the page-A. If not, the process returns to Start. If the downloading of page-A into the memory 18 is ready (step S3), the page-A is downloaded (step S4). The HTML source file of the page-A is analyzed (step S5), and whether image data are included is checked (step S6). If a tag indicating to download the image data is included, such image data are downloaded (step S7), and if not, the process returns to Start. Whether the special command to change the setting is included is checked (step S8). If the special command is included, the data for changing the setting are read out from the memory 18 (step S9), and if not, the process returns to Start. Finally, the setting of the phone 2 is changed (step S10) and the process returns to Start.

If a phone 2 made by other makers than D is connected to the exclusive server 7 and the special command is sent to that phone, the special command cannot be recognized as a command to change the setting, because such information is not included in that phone. The image data requested by such a phone can be normally downloaded and displayed, but the setting is not changed. This means that, upon receipt of the special command, the setting of the phone 2 made by D is changed, while the setting of the phones made by others is not changed. Thus, the phone maker D is able to offer a special amusement only to the user of its own phone. The user will enjoy, with a surprise, the change appearing on his phone only by visiting the internet site of the phone maker D. This would give the user some more incentive to visit the site of the phone maker D.

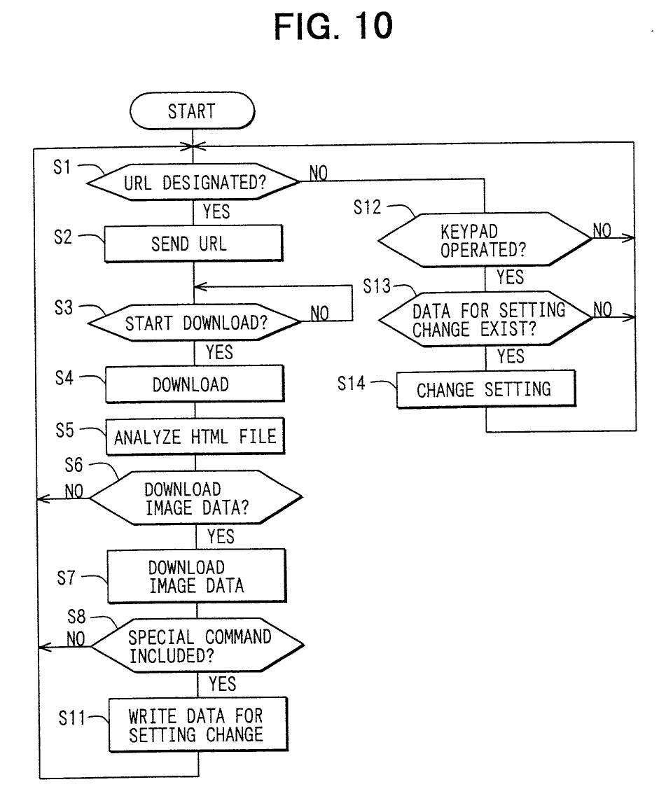

A third embodiment of the present invention will be described with reference to FIGS. 9 and 10. Since this embodiment is similar to the second embodiment, only the features and functions peculiar to this embodiment will be described below. In this embodiment, the data for changing the setting of the phone 2 are not pre-installed in the memory 18. Referring to FIG. 9, a communication process in this embodiment will be described. The user designates URL for locating the exclusive server 7 to request the page-A in the same manner as in the second embodiment. The page-A is downloaded into the mobile phone 2. If image data are included in the downloaded data, the user requests the image data to be downloaded. The image data sent from the exclusive server 7 include the data for changing the setting in addition to the special command. Then, the setting is changed upon operation of the keypad 10 by the user.

The above communication process will be explained with reference to the flowchart shown in FIG. 10. The steps from step S1 to step S8 are the same as those in the second embodiment. If the special command is included (step S8), the special command is downloaded together with the data for changing the setting of the mobile phone 2, and those data are written in the memory 18 (step S11). Then, the process moves to step S1. If the answer of step S1 is NO, the process moves to step S12 where whether the user has operated the keypad 10 is determined. If the user has operated the keypad 10, whether the data for changing the setting are memorized in the memory 18 or not is determined (step S13). If the data are memorized, the setting of the phone 2 is changed according to the data (step S14). For example, message characters shown on the display panel 11 are changed. Then, the process moves to step S1. In either case where the answer from step S12 or S13 is NO, the process returns to step S1. In other words, as opposed to the second embodiment, the phone setting is not automatically changed upon receipt of the special command, but it is changed when the user operates the keypad 10.

Since, in the third embodiment, the data for changing the phone setting are downloaded from the exclusive server 7 together with the special command, it is not necessary to pre-install those data in the memory 18. Further, since such data can be altered in the exclusive server 7, e.g., with predetermined intervals, the user enjoys various settings of his phone.

The second and the third embodiments described above may be variously modified. For example, in the second embodiment, either one of the images, characters or melodies, or any combination thereof, or all of them may be changed in the phone setting change. In the third embodiment, the steps S12-S14 may be carried out also when the answer from step S1 is YES. The data for changing the phone setting downloaded together with the special command may be data not only for changing the character message but also for changing images to be displayed, melodies or a voice message to be output from the speaker 20. The data for changing the phone setting may be requested by the user after he recognizes the special command.

Though the special command is written in the header field of the TCP/IP data format in the second and third embodiments, it is also possible to write it at the end of the data field. Alternatively, the special command may be added at a place outside the region specified by a total length of the header field. The setting change may be made effective for a predetermined period of time so that it returns to an original setting after the predetermined time lapses. The client terminals are not limited to the mobile phones, but other terminals such as PHS terminals or personal computers having a communication modem.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A client server system for supplying information to client terminals, the client server system comprising:
an exclusive server storing information therein;
means for specifying the client terminal by a code identifying a maker of the client terminal, the code being sent from the client terminal to the exclusive server; and
means for supplying information stored in the exclusive server to the specified client terminal.

2. The client server system as in claim 1, wherein:
the supplying means rejects access to the exclusive server against an unspecified client terminal.

3. The client server system as in claim 1, wherein:
the exclusive server stores information exclusive to the specified client terminals and public information; and
the supplying means supplies the exclusive information only to the specified client terminals, while supplying the public information to any client terminals.

4. The client server system as in claim 1, wherein:
the client terminals are mobile phones which are able to communicate with the exclusive server via a provider's server administered by a telephone service provider;
the mobile phone sends the maker-identifying code and another code identifying the provider to the provider's server;
a data format including both identifying codes is sent from the provider's server to the exclusive server; and
the exclusive server supplies the information stored therein to the mobile phone only when both codes are justified as codes correctly identifying the maker and the provider.

5. The client server system as in claim 4, wherein:
the data format sent form the provider's server to the exclusive server consists of a header field having a predetermined format and a data field in which data are arbitrarily written; and
of both codes, at least the maker-identifying code is contained in the data field.

6. A mobile phone communicable with an exclusive server administered by a maker which made the mobile phone, the mobile phone comprising:
a pre-installed locator for locating the exclusive server to download contents stored in the exclusive server and made available only to the mobile phone having the locator.

7. A mobile phone communicable with an exclusive server administered by a maker which made the mobile phone, the mobile phone comprising:
a pre-installed browser for downloading contents stored in the exclusive server and made available exclusively to the mobile phone having the browser.

8. A client server system for supplying information to client terminals, the client server system comprising:
an exclusive server storing specified contents to be supplied to the client terminals;
means for downloading the specified contents stored in the exclusive server to the client terminals, wherein:
the specified contents are accompanied by a special command;
the specified contents are downloaded together with the special command; and
upon receipt of the special command, a setting of the client terminals recognized as specified terminals by the exclusive server is changed.

9. The client server system as in claim 8, wherein:
data for changing the setting of the specified terminal are downloaded from the exclusive server.

10. The client server system as in claim 9, wherein:
the data for changing the setting are downloaded together with the special command.

11. The client server system as in claim 8, wherein:
the specified contents are sent from the exclusive server to the client terminals in a specified data format having a header field and a data field; and
the special command is contained in the header field.

12. The client server system as in claim 8, wherein:
the client terminals are mobile phones.

13. The client server system as in claim 12, wherein:
the mobile phone includes a display panel; and
the setting of the mobile phone is changed by changing images displayed on the display panel.

14. The client server system as in claim 12, wherein:
the mobile phone includes a display panel; and
the setting of the mobile phone is changed by changing a character message shown on the display panel.

15. The client server system as in claim 12, wherein:
the mobile phone includes a sound generator for outputting music; and
the setting of the mobile phone is changed by changing the music output from the sound generator.

16. The mobile phone for use in the client server system defined in claim 12.
